(19) United States
(12) Patent Application Publication
(10) Pub. No.: US 2006/0085815 A1
(43) Pub. Date: Apr. 20, 2006

(54) Multimedia advertising marketplace

(75) Inventor: Trang Nguyen-Tran, Hackensack, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/965,818

(22) Filed: Oct. 18, 2004

(51) Int. Cl. H04N 7/10; H04N 7/025

(52) U.S. Cl. 725/34; 725/35

(57) ABSTRACT

A method for matching advertisements with broadcasts includes: receiving at least one characteristic of an advertisement into a pool of available advertisements; searching the pool of available advertisements for a broadcasting match to the at least one characteristic; and signaling that the advertisement matches the at least one characteristic. Another method includes: receiving at least one characteristic of a broadcast into a pool of available broadcasts; searching the pool of available broadcasts for an advertising match to the at least one characteristic; and signaling that the broadcast matches the at least one characteristic. A system includes: a database containing information related to at least one of a broadcast and an advertisement; a search engine to search the database based on at least one characteristic received; and a signal that the at least one characteristic matches at least one of the at least one broadcast and at least one advertisement.

### BACKGROUND OF THE INVENTION

### Field of the Invention

In the world of program broadcasting, it is often difficult for advertisers to reach the desired public. Typically, advertisers go through brokers and agencies (hereafter brokers). A problem with the broker system is that broadcasters cannot get access to enough advertisers to sell all available advertising segments. Broadcasters are unable to access enough advertisers because brokers generally present favored clients and connect broadcasters with advertisers based on the brokers' individual biases.

Another flaw of the broker system is that smaller network radio stations in more rural areas are not able to meet with the advertising brokers, and are generally less financially powerful. Thus, smaller network radio stations are not viewed as favorably by the brokers. Generally speaking, brokers do not make a large effort to accommodate the needs of the smaller network radio stations, especially those in rural areas, because the brokers are mainly focused on larger radio stations in urban areas.

Moreover, it is very costly to obtain a broker. National advertisers generally acquire advertising segments through the brokerage process. However, local advertisers (especially those with smaller budgets) might directly contact an individual broadcaster.

As a general rule, when an advertiser desires his advertisement to be broadcast in a certain region or for a certain age group, the advertiser must call a broker. The broker then calls the station. This entire process is very time consuming and cost inefficient.

The sale of advertising segments is an important source of revenue for the broadcaster. The advertising segments are blocks of time that the broadcaster sets aside for advertisements. Presently, broadcasters rely on brokers to help market their advertising segments to advertisers. Typically, each broadcaster has a single broker that is responsible for marketing all of the broadcaster's available advertising segments in a given region.

One problem with this approach is that a broker tends to have access only to a limited set of advertisers. Often, the broker is unable to sell all of the available advertising segments to advertisers. As a result, the broadcasters are left with a significant amount of unsold advertising segments (e.g. inventory).

Additionally, advertisers and broadcasters alike may have unused options on advertising segments. These unused and untransferred segments represent market loss. Often, brokers are either unable or unwilling to obtain buyers for a broadcaster's unused inventory.

In other cases, a broadcaster may have insufficient advertising segments in a particular type of broadcast media while having excess inventory in another type of broadcast media. For example, a broadcaster may have excess radio inventory while simultaneously having insufficient television inventory. Thus, the broadcaster may suffer lost revenue in a case where an advertiser desires a particular broadcasting medium, such as television, and the broadcaster is unable to provide advertising segments for that desired medium.

To overcome this difficulty, the Applicants of the present invention developed a system whereby advertising segment owners may directly exchange advertising segment inventory for a variety of broadcast media, thereby reducing the deadweight loss of unused or insufficient advertising segments.

### SUMMARY OF THE INVENTION

The present invention was developed in light of the above-described difficulties and provides a more efficient system and/or service for enabling broadcasters to sell advertising segments and for enabling advertisers to access the advertising segments. To do this, the system according to the present invention provides a database that includes information describing available advertising segments and a controller for enabling advertisers and broadcasters to access the database from a remote terminal through a communication medium. The system enables broadcasters to list or post available advertising segments in the database, and enables advertisers to review the information describing the listed segments and to purchase a segment as needed.

Information describing the available advertising segments may include, for example, a duration of the segment, a geographical region in which the segment will be broadcast, the type of broadcast (e.g., radio, television, or other broadcast), a time of day the segment will be broadcast, as well as cost. The database also enables advertisers to review and choose from a list of available segments that may or may not be selected based on search criteria input via a remote terminal by the advertiser. Thus, it is possible to eliminate the need for the broker relationship, and it is possible to provide advertisers with access to a broader range of choices. The present invention also enables broadcasters to reach a wider range of advertisers. The present invention may be accessible via any known means of communication, including telephone, internet, wireless device, or other communication method.

Through the present invention, it is also possible for advertisements and owners of content-based media to sell advertisements and advertising segments based on desired characteristics, such as geographic location, demographic characteristics, local, national, or international advertising requirements, as well as other desired factors.

To this end, one aspect of the present invention provides a method for matching advertisements with broadcasts, the method including: receiving at least one characteristic of an advertisement into a pool of available advertisements; searching the pool of available advertisements for a broadcasting match to the at least one characteristic; and signaling that the advertisement matches the at least one characteristic, wherein the at least one characteristic includes a type of broadcast.

Another aspect of the present invention provides a method for matching advertisements with broadcasts including: receiving at least one characteristic of a broadcast into a pool of available broadcasts; searching the pool of available broadcasts for an advertising match to the at least one characteristic; and signaling that the broadcast matches the at least one characteristic, wherein the at least one characteristic includes a type of broadcast.

Yet another aspect of the present invention provides a method for matching broadcasts with advertisements, the method including: receiving at least one first characteristic of a broadcast into a pool of available broadcasts; receiving at least one second characteristic of an advertisement into a pool of available advertisements; searching the pool of available broadcasts and the pool of available advertisements for a match between the at least one first characteristic or the at least one second characteristic; and signaling that the advertisement matches the at least one first characteristic or that the broadcast matches the at least one second characteristic, wherein the at least one characteristic includes a type of broadcast.

The present invention also provides a method for matching advertisements with broadcasts, the method including: displaying at least one first characteristic of at least one available broadcast from a pool of available broadcasts; and enabling a user to select the at least one available broadcast based on the at least one first characteristic, wherein the at least one characteristic includes a type of broadcast.

A method for matching broadcasts with advertisements is also provided, the method including: displaying at least one first characteristic of at least one available advertisement from a pool of available advertisements; and enabling a user to select the at least one available advertisement based on the at least one characteristic, wherein the at least one characteristic includes a type of broadcast.

Another aspect of the present invention provides a system for matching broadcasts with advertisements, the system including: a database containing information related to at least one of a broadcast and an advertisement; a search engine configured to search the database based on at least one characteristic received; and a signal to indicate that the at least one characteristic matches at least one of the at least one broadcast and at least one advertisement, wherein the at least one characteristic includes a type of broadcast.

Yet another aspect of the present invention provides a system for providing advertisers with access to advertising segments in broadcasts, the system including: a database comprising information describing available advertising segments in broadcasts; and a controller configured to provide said information to a remote terminal through a communication medium and to process a selection of a first available advertising segment in said database from the remote terminal, wherein the at least one characteristic includes a type of broadcast.

Thus, the present invention addresses at least some of the difficulties of unfilled advertising segments and unsold promotional information. Therefore, it is possible for both advertisers and broadcast owners to more efficiently reach the public and each other with desired services and products.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 represents the Multimedia Advertising Marketplace with multiple advertisers and a single broadcast owner interacting to obtain matching of advertising with broadcast content;

FIG. 2 represents a single advertising promotional information owner interacting with a plurality of broadcast owners to obtain matching of advertising with broadcast content;

FIG. 3 represents multiple advertisers using the Multimedia Advertising Marketplace to interact with multiple broadcasters to obtain matching of advertising with content;

FIG. 4 represents a non-limiting illustration of a computer that may be used to implement the method and/or system of the present invention;

FIG. 5 represents a login page for either an advertiser or a broadcaster or other system user for the Multimedia Advertising Marketplace;

FIG. 6 represents a screen that a user/broadcaster may see when logged into the system;

FIG. 7 represents a user/broadcaster's listing of available advertisements;

FIG. 8 represents a more detailed version of FIG. 7;

FIG. 9 illustrates available advertisements for a user/broadcaster by brand;

FIG. 10 illustrates available advertisements for Brand 1;

FIG. 11 illustrates a screen for placing or accepting a bid;

FIG. 12 illustrates a miscellaneous usage screen for a user/broadcaster;

FIG. 13 illustrates a welcome page for a user/advertiser of the present invention;

FIG. 14 illustrates available broadcasts that may be viewed by a user/advertiser who is logged into the system;

FIG. 15 represents the available broadcasts with nodes expanded for further details;

FIG. 16 represents a further illustration of the subject matter of FIG. 15;

FIG. 17 represents in more detail characteristics of the East coast broadcast of FIG. 16;

FIG. 18 illustrates a screen that a user/advertiser may see to place or accept a bid;

FIG. 19 represents a search page for either a user/advertiser or a user/broadcaster;

FIG. 20 illustrates a method of matching advertising to a broadcast;

FIG. 21 represents a method matching broadcasts to advertising; and

FIG. 22 represents a screen that a user may view when searching available inventory.

### DETAILED DESCRIPTION OF THE EMBODIMENTS

Through the Multimedia Advertising Marketplace, it is possible for user/advertisers to buy advertisement time and for user/broadcasters to sell available advertising time, up to and during an actual broadcast. Because advertisements in broadcasts are frequently streamed via satellite, it is easy for a user/advertiser or user/broadcaster to insert advertisements at the very last second. Additionally, advertisements may be streamed over the internet in MP3 or other form. The present invention also enables a user/advertiser or a user/broadcaster to insert advertisements in broadcasts at the very last moment using internet transfer technologies. Accordingly, the present invention enables a greater improvement for interfacing between user/advertisers and user/broadcasters.

To facilitate use of the marketplace by user/broadcasters and user/advertisers alike, it is possible for a user/broadcaster to search for desired content based on subject matter, time of day desired, demographics, target audience, type of advertising (e.g., local, national, or international), as well as any other desired characteristics, which will be described in detail below. This ease of searchability enables both user/advertisers and user/broadcasters to search more efficiently for a business partner.

Additionally, user/broadcasters may seek out user/advertisers that they wish to target. For example, by searching for a user/advertiser by criteria such as subject matter, it may be possible for a user/broadcaster to initiate long term business relationships or even short term business relationships, depending on the user/broadcaster's and user/advertiser's respective needs.

According to a first non-limiting embodiment of the present invention, representatives of advertising segments (e.g., broadcast owners, brokers, or other agents) may access a central clearinghouse (hereafter “the marketplace”) with information relating to available advertising promotional information and the content of broadcasts.

For example, Broadcaster A may feature a broadcast relating to reviews of children's books. Broadcaster A may then provide the marketplace with information, such as the target audience (e.g., parents of young children), the nature of the media broadcast content (e.g., children's book reviews), the broadcasting date and time, the run length of the broadcast, and the number of segments available for advertising promotional information for local, national, and international needs. Broadcaster A may also indicate the lengths of the available advertising segments.

As an alternative embodiment of the present invention, Broadcaster A may provide the marketplace with information on user/advertisers who previously purchased available time slots. In this case, if there is a conflict of interest between potential advertisers, the present invention may enable identification of the conflict. For example, if a local merchant purchased a slot, Broadcaster A may provide the marketplace with pertinent information about the purchased time segment (e.g., the types of goods advertised, the target age group, or other target information). The information either may include the local merchant's identifying information or may be anonymous. Accordingly, if any conflicts exist between merchants (e.g., a local toy maker, a national toy maker, or a toy distributor), the national merchant may be informed of the conflict and optionally may be prevented from purchasing available advertising segments from Broadcaster A in the children's book review broadcast. Alternatively, the marketplace may notify Broadcaster A of the conflict and allow Broadcaster A to decide to accept the conflicting user/advertiser and reject the previous user/advertiser or to accept both.

The marketplace also accepts information from user/advertisers. For example, continuing the non-limiting example of Broadcaster A, Advertiser 1 may wish to purchase advertising time from Broadcaster A in the children's book review segment. Advertiser 1 may have promotional information, such as promotional information related to a restaurant designed for children or for hosting children's birthday parties, for example. Advertiser 1 may wish for his advertisements to be played immediately following discussion of a book about children's recipes. In this case, it is possible for Advertiser 1 to request a particular time segment and for the marketplace to identify any potential conflicts. If no conflicts are identified, the marketplace arranges for Advertiser 1's bid to be communicated to Broadcaster A. Broadcaster A may then accept or decline the offer from Advertiser 1.

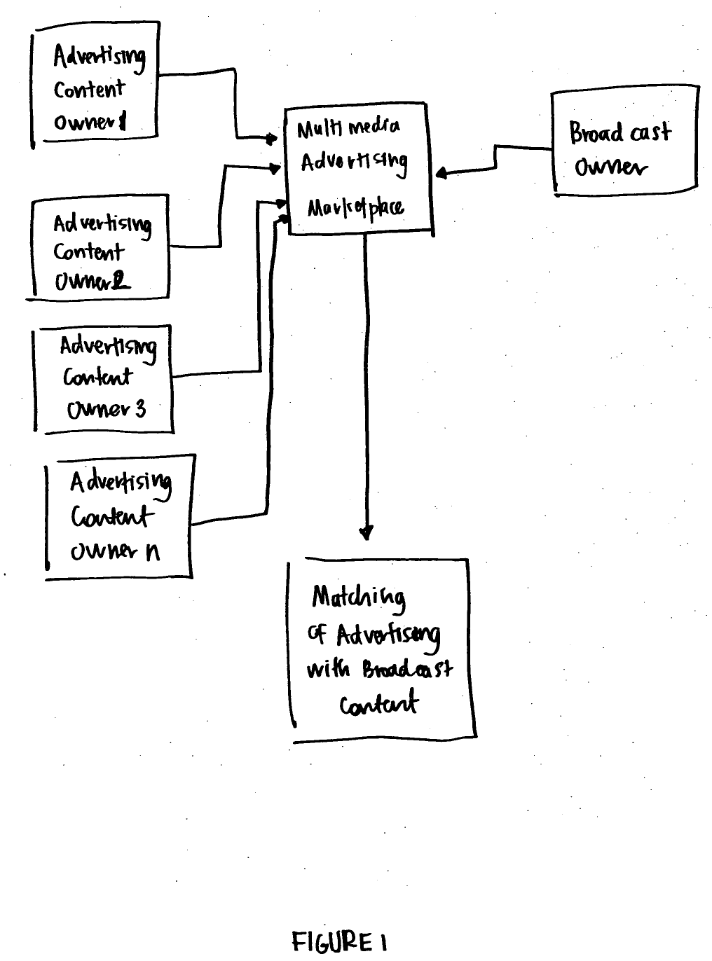

As illustrated in FIG. 1, it is possible for multiple advertising promotional information owners (e.g., advertising promotional information owner 1 through advertising promotional information owner n) to interact with the Multimedia Advertising Marketplace with only a single broadcast owner. This broadcast owner may review bids from all the advertising promotional information owners and may offer bids to all the advertising promotional information owners to obtain matching of advertising with broadcast content (e.g., an advertising match). These bids may be based on a variety of characteristics, such as those enumerated herein, as well as other factors that will be readily apparent to one skilled in the art. If a bid is accepted, the broadcast owner has obtained a finalized advertising match.

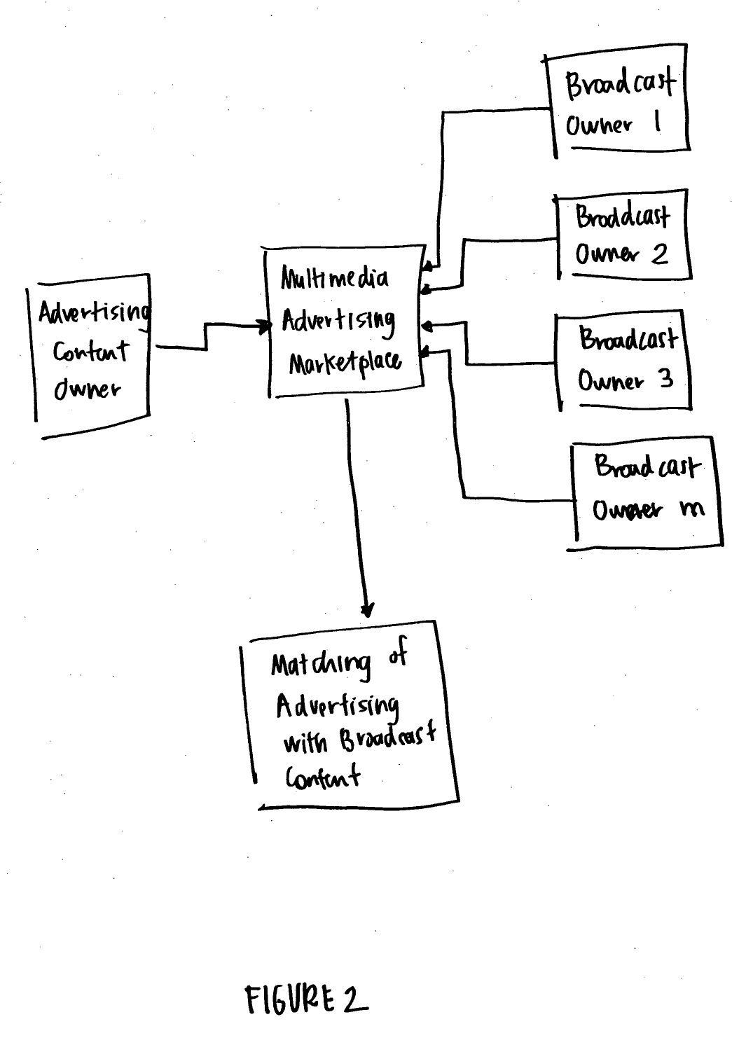

FIG. 2 illustrates the situation where a single advertising promotional information owner submits information to a pool of available advertisements in the Multimedia Advertising Marketplace that is viewed by a plurality of broadcast owners. This plurality of broadcast owners (e.g., broadcast owner 1 through broadcast owner m) may interact with the single promotional information owner to compete for advertising promotional information available or to offer discount prices on certain time segments. Through the Multimedia Advertising Marketplace, the advertising promotional information owner and broadcast owners are able to obtain improved matching of advertising with broadcast content. A broadcasting match is obtained when an advertiser locates a broadcast from a pool of available broadcasts that is compatible with his advertising needs. Once an advertiser accepts an offer from or has an offer accepted by a broadcast representative, he has obtained a finalized broadcasting match.

When either a broadcasting match or an advertising match is identified from the pool of available broadcasts or from the pool of available advertisements, the Multimedia Advertising Marketplace signals the representative of the broadcasting match, the advertising match, or both. Signaling may include outputting a visual signal, an electronic message, an aural indicator, or other equivalent signal apparent to one of ordinary skill in the art.

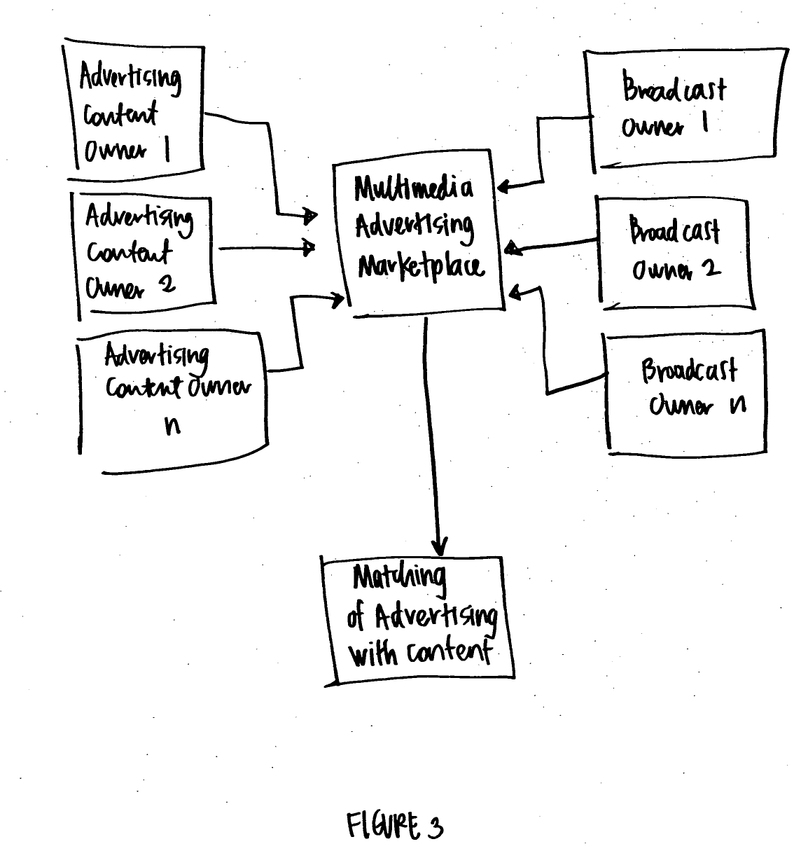

Similarly, FIG. 3 illustrates a situation in which a plurality of advertising promotional information owners interacts with a plurality of broadcast owners in the Multimedia Advertising Marketplace. The level of interactions between these two groups may be varied, and will be explained in detail further. Through the Multimedia Advertising Marketplace, the plurality of advertising promotional information owners and the plurality of broadcast owners are able to obtain better matching of advertising with content, thereby improving market efficiency.

Alternatively, it is possible to have an auction situation, where multiple user/advertisers may bid for the same advertising segment, as illustrated, for example, in FIGS. 1 and 3. In such a case, a user/broadcaster may set a reserve limit (e.g., a minimum price) at which the user/broadcaster is willing to sell the advertising segments. This minimum price may or may not be set, depending on the parameters of the auction set by the user/broadcaster. This minimum price may also reflect the time limits of the user/advertiser's request. For example, the price may be set higher or lower, depending on the parameters of the auction set by the user/broadcaster, and other characteristics such as the popularity of the particular broadcast show, as well as based on the length of time between the user/advertiser's request and the scheduled run time of the user/broadcaster's broadcast. For example, a user/broadcaster with significant amounts of excess broadcast advertisement segments may wish to discount available segments to a cheaper price, to increase the likelihood that the segments are filled.

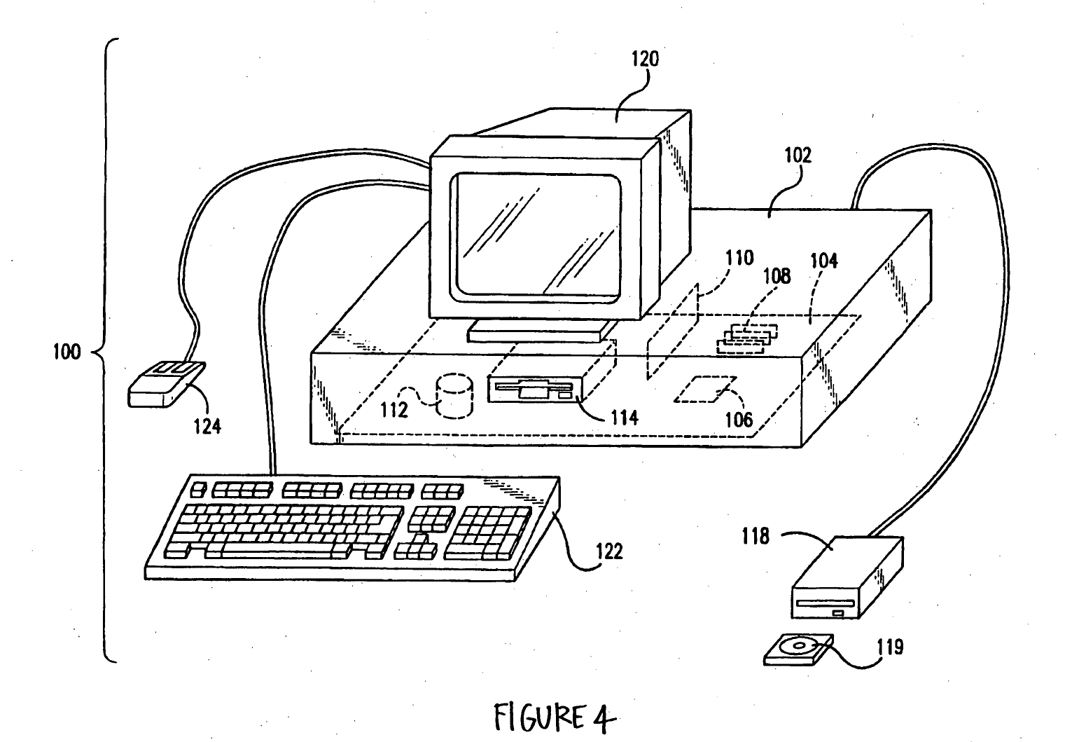

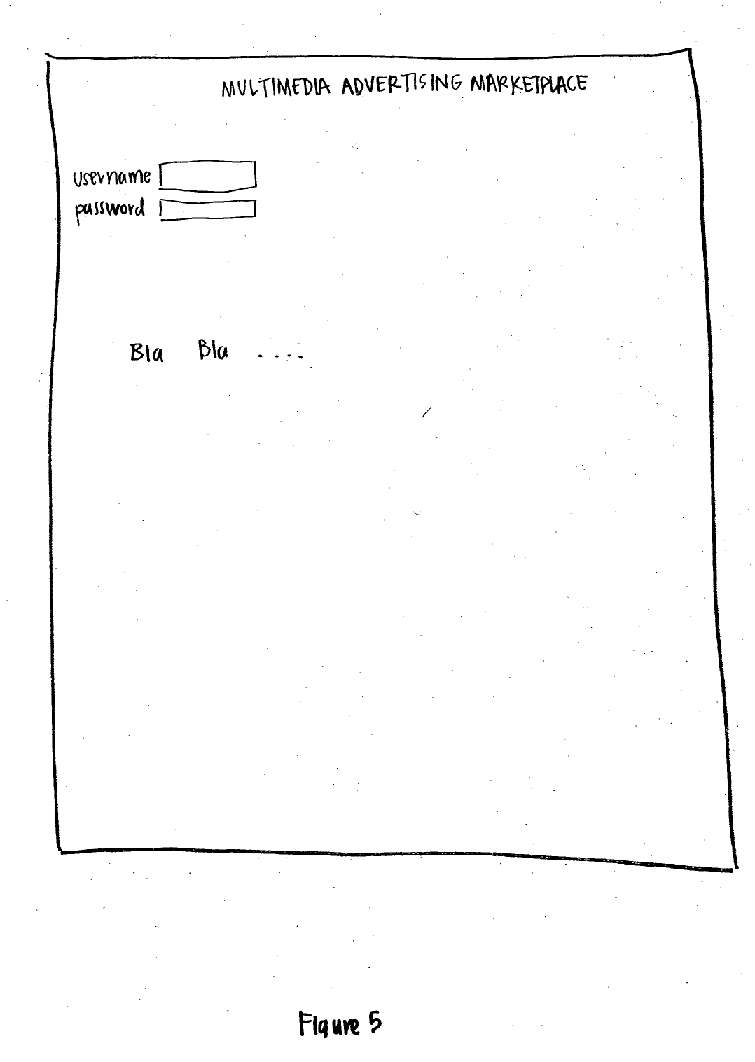

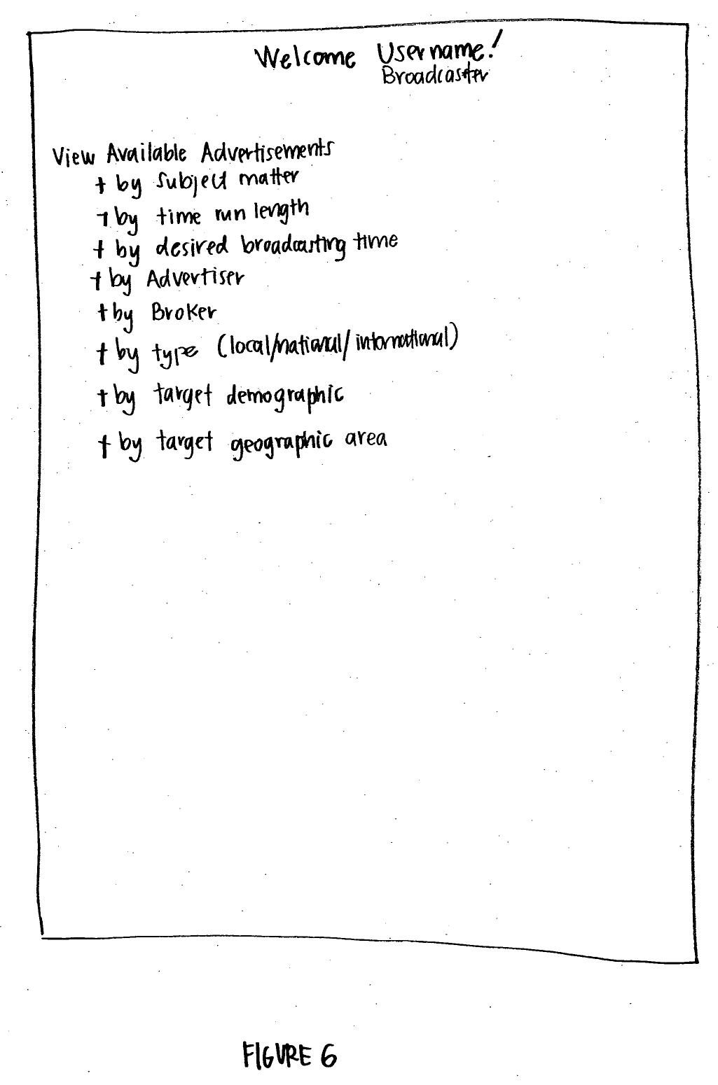

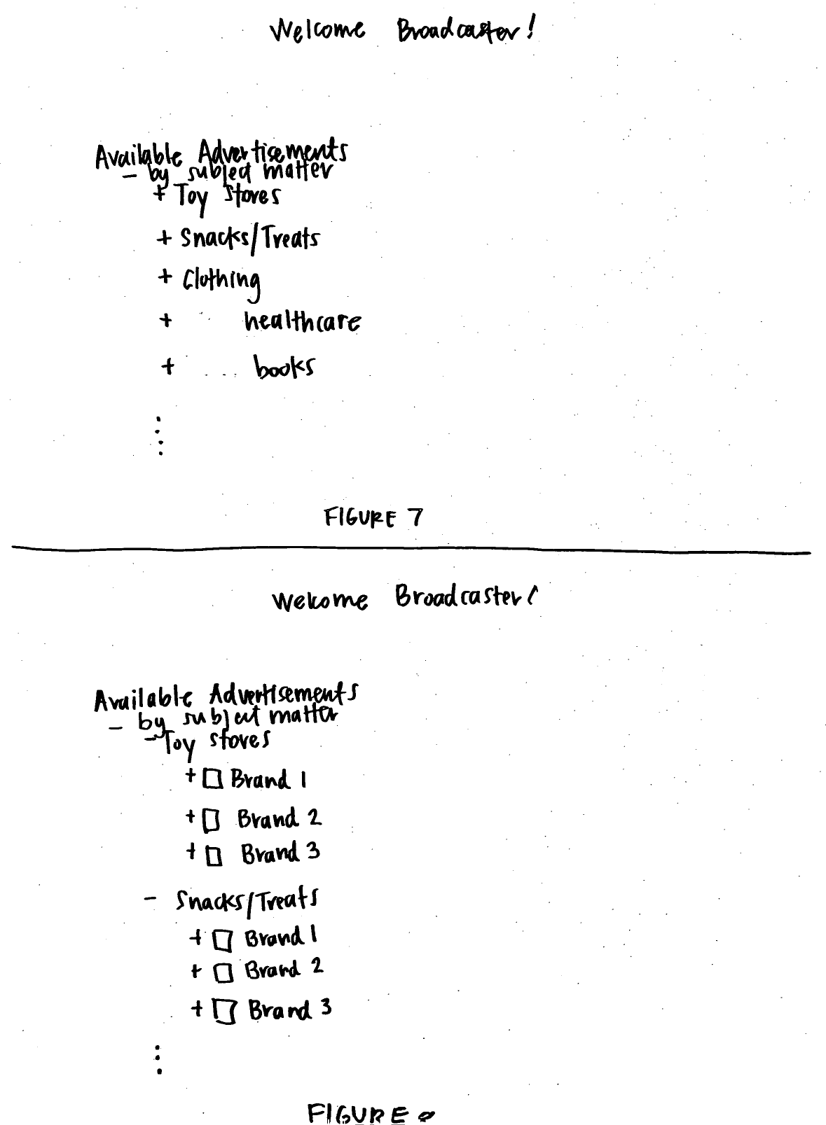

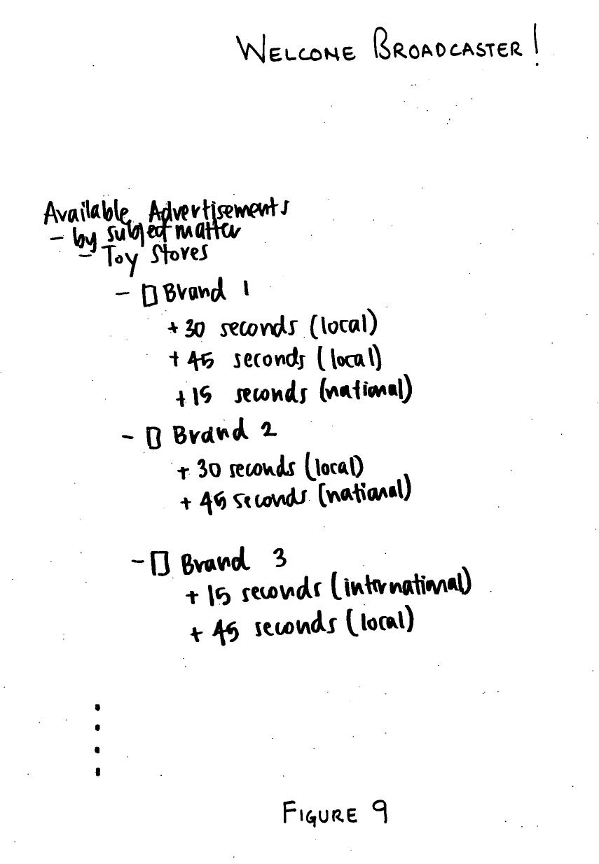

FIG. 4 is a schematic illustration of a computer system that may be used to implement the Multimedia Advertising Marketplace. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) may also provide printed listings of available advertising segments, broadcasts, or advertising promotional information.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for the Multimedia Advertising Marketplace. The computer code devices of the present invention can be any interpreted or executable code mechanism, including but not limited to scripts, interpreters, dynamic link libraries, Java classes, and complete executable programs. The invention may also be implemented by appropriate application specific integrated circuits or by interconnecting an appropriate network of conventional component circuits, as will be readily apparent to those skilled in the art.

FIG. 5 illustrates a login screen for a user of the Multimedia Advertising Marketplace. Users may include potential advertisers, potential user/broadcasters, broadcasting and advertising brokers, intermediaries, as well as administrators or other users of the Multimedia Advertising Marketplace.

Once the user/broadcaster logs in as illustrated in FIG. 5, the user/broadcaster is directed to a welcome screen reflecting the username. A welcome screen for a user/broadcaster is illustrated in FIG. 6. As illustrated on the welcome screen of FIG. 6, some non-limiting examples of subject matter that may be displayed include viewing available advertisements by subject matter, by time run length, by desired broadcasting time, by user/advertiser, by broker, by type (e.g., local/national/international), by target demographic, and by target geographic area. This list is intended to be illustrative, and not limiting of the present invention.

FIG. 7 illustrates a non-limiting example when a user/broadcaster clicks on the subject matter link. The subject matter link may be spread out to display the subject matter available as advertising promotional information. In the non-limiting example of FIG. 7, subject matter available includes toy stores, snacks/treats, clothing, healthcare, and books. Again, this list is to be considered illustrative and not limiting of the present invention.

If a user/broadcaster wants to view any of the nodes in more detail, he may click on the node to obtain more information. FIG. 8 illustrates the nodes for toy stores and snacks/treats as expanded. As illustrated in FIG. 8, the subject matter branches are expanded so that the brands available for advertising promotional information are evident to the user/broadcaster. Depending on the user/broadcaster settings (or administrative settings) of the Multimedia Advertising Marketplace, the user/broadcaster may view other characteristics and information about the available broadcasting segment. Additionally, certain user/advertisers may select to be restricted from viewing by certain user/broadcasters.

FIG. 9 illustrates in more detail the advertising promotional information available for each of the brands listed in FIG. 8. As seen in FIG. 9, a user/broadcaster may view the time lengths of the advertising promotional information available, as well as the local/national/international character of the advertising promotional information available. The user/broadcaster may click on any of the links present to obtain further information.

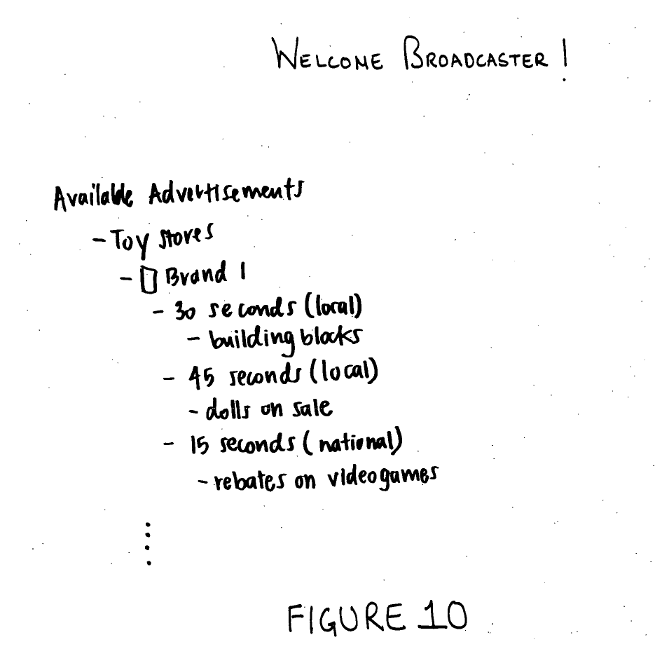

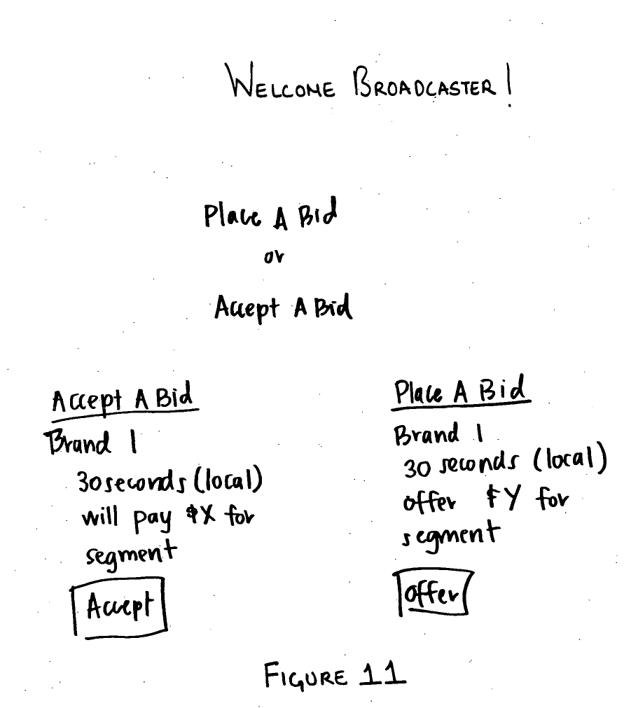

FIG. 10 illustrates what happens when a user/broadcaster expands the nodes for each of the time segments listed. This more particular subject matter of those time segments is then evident to the user/broadcaster, as it is displayed on the screen.

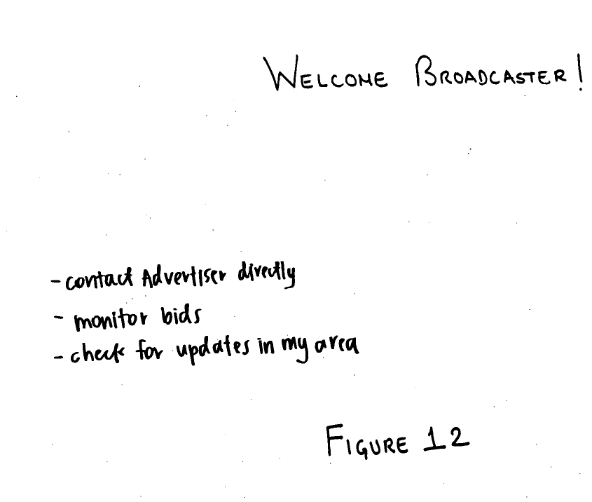

FIG. 11 illustrates how a user/broadcaster may place or accept a bid. As illustrated in the non-limiting example of FIG. 11, a user/broadcaster may accept a bid offered by brand 1 for the 30 seconds of local subject matter. In the non-limiting example of FIG. 11, Brand 1 will pay $X for the available segment time of 30 seconds. If the user/broadcaster desires to accept this bid, he may click on the accept button. Alternatively, if a user/broadcaster wants to place a bid, it is possible to enter an offer price (e.g., $Y) for a particular available time segment.

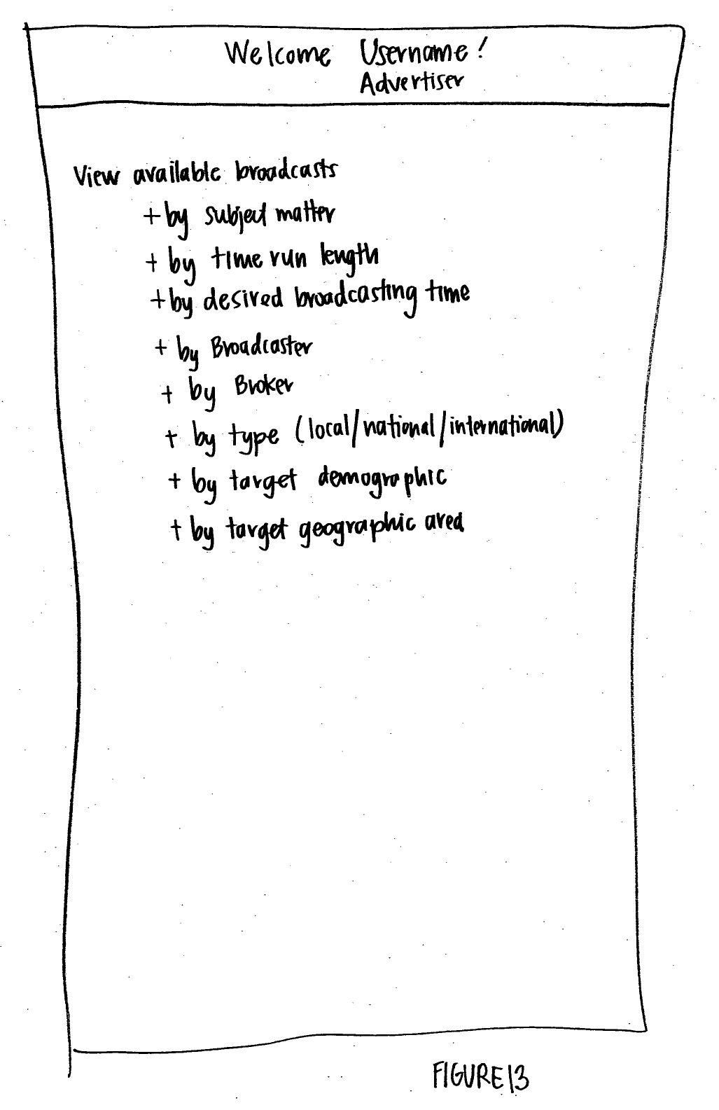

If the user/broadcaster does not wish to place or accept a bid as illustrated in FIG. 11, the user/broadcaster may contact the user/advertiser directly, monitor other bids, or check for updates in the available advertising or broadcasting area, as illustrated in FIG. 12. Conversely, a user/advertiser may set a maximum price that he is willing to pay to obtain the advertising segments, as illustrated in FIG. 11. The advertiser may include other characteristics desired, such as segment time desired (e.g., length), the broadcast time desired (e.g., within the broadcast itself as well as the start/stop time of the broadcast), and the subject matter of the broadcast, as well as other features. These desired inputs aid a user/advertiser in selecting the available advertising segments that best suit his needs.

Additionally, the marketplace may include continuous polling features. For example, both user/broadcasters and user/advertisers may input both availability characteristics (e.g., advertising segments or options available by either) and desirability characteristics (e.g., a user/advertiser is looking for 30 seconds of segment time at a cooking show). The marketplace is capable of continuously monitoring the available contents and segments and notifying user/broadcasters and user/advertisers (e.g., by email or by pop-up messaging) of a potential match for their respective needs. User/broadcasters of the marketplace may also instruct the marketplace to search for the availability of advertising promotional information or advertising segments that are available to, related to, or resemble prior selections (e.g., the characteristics of prior segments purchased or prior promotional information use in sold segments). User/broadcasters may be notified of potential matches by any chosen method of communication (e.g., email, telephone, pop-up messaging).

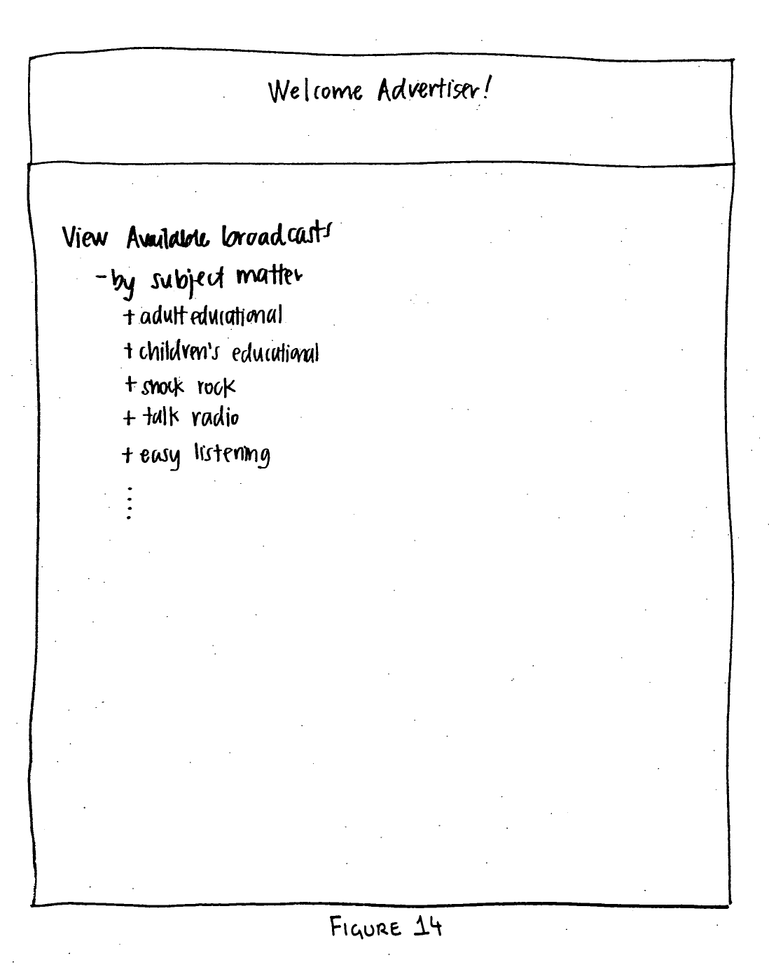

FIG. 13 is a non-limiting example of when a user/advertiser logs in. As is evident from FIG. 13, a user/advertiser may view available broadcast by subject matter, by time run length, by desired broadcasting time, by user/broadcaster, by broker, by type (local/national/international), by target demographic, and by target geographic area. This list is in no way intended to be limiting, and merely represents examples of the subject matter that may be displayed to a user/advertiser, based on the user/advertiser's display settings or administrative controls.

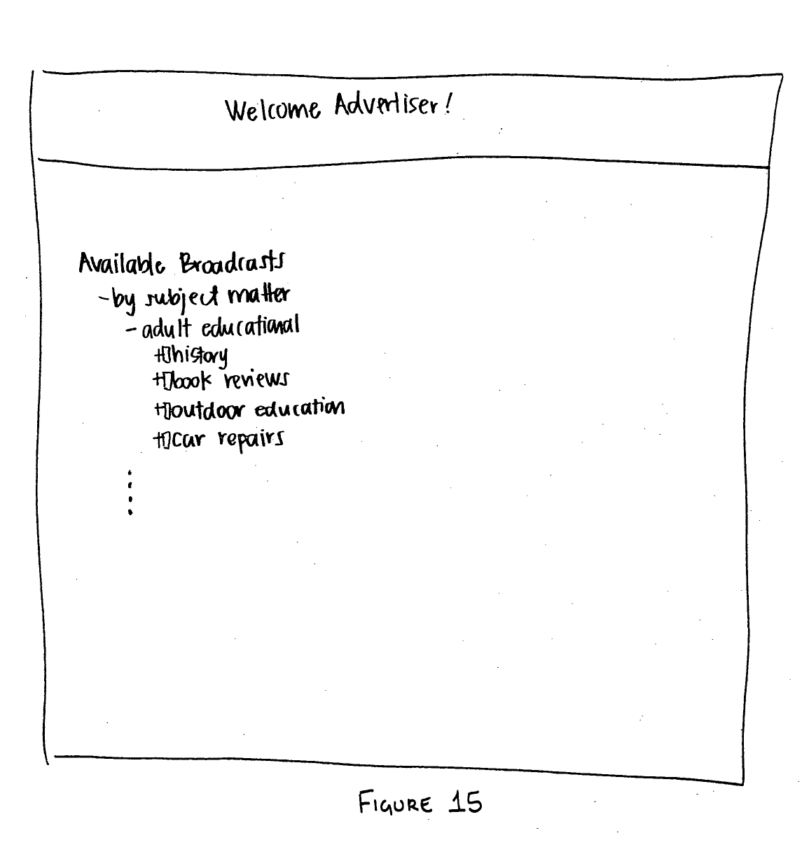

Once the user/advertiser selects a node, such as, for example the by subject matter node of FIG. 13, the advertiser will be led to a screen such as that illustrated in FIG. 14. As illustrated in FIG. 14, broadcasts may be viewed by available subject matter. This subject matter may include, as non-limiting examples, adult educational programs, children's educational programs, shock rock, talk radio, and easy listening. If, for example, the user/advertiser is interested in adult educational shows, the advertiser may click on the adult educational link to expand the node to view further detailed options. The advertiser may modify the broadcasts displayed by changing user/advertiser settings at any time.

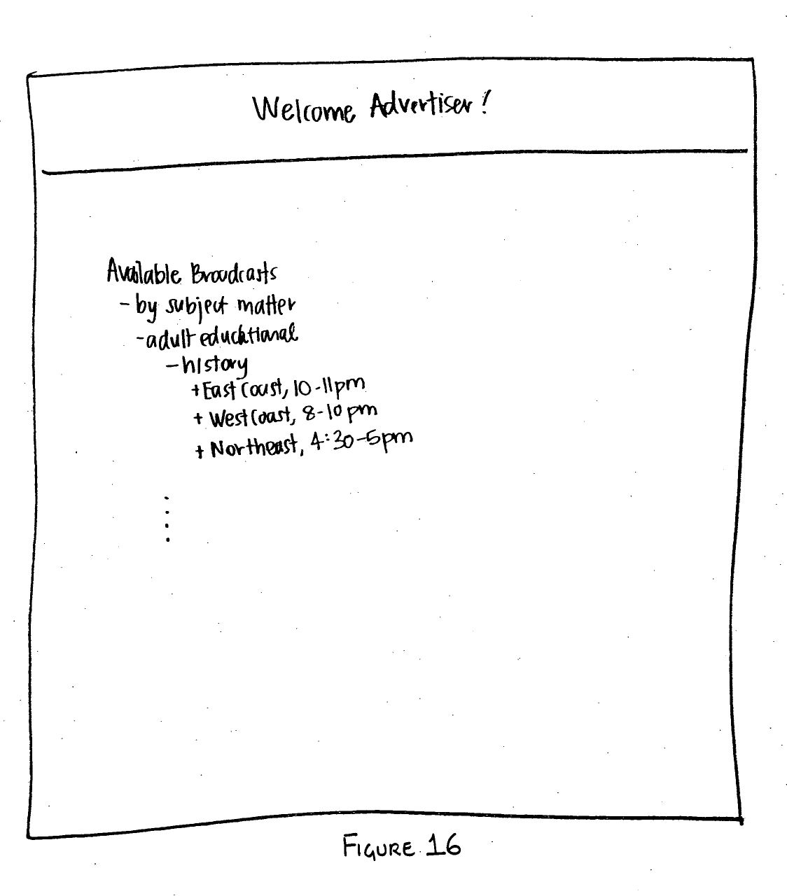

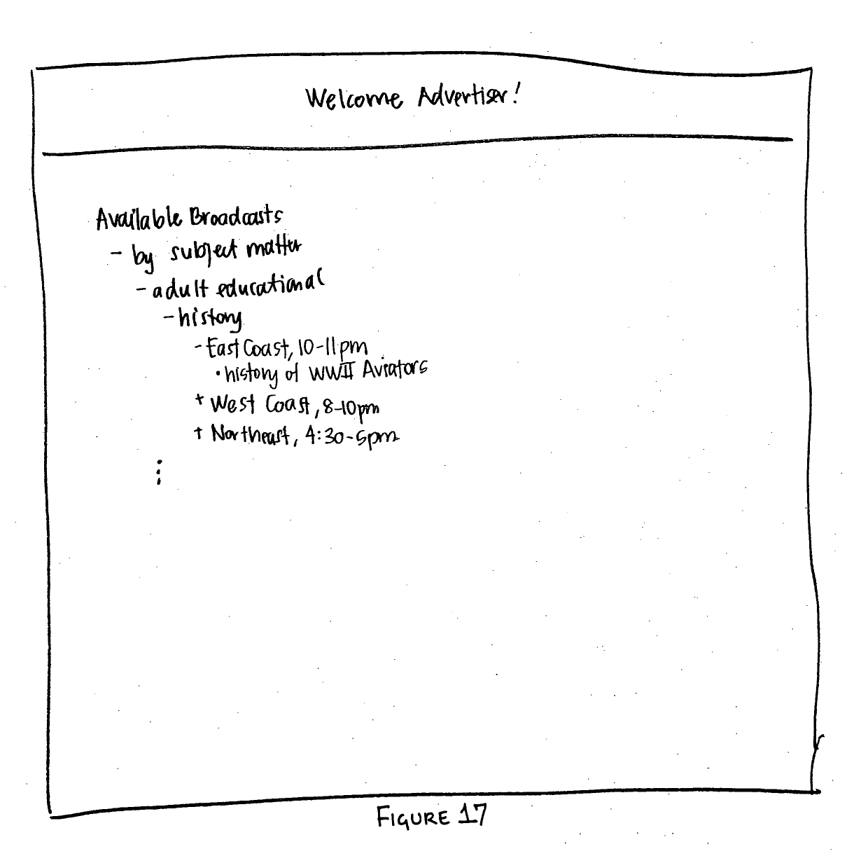

As illustrated in FIG. 15, the further detailed options may include, for example, in the adult educational section, history, book reviews, outdoor education, as well as car repairs. If the advertiser's promotional information most closely matches that of history educational programs, the advertiser may expand the node at the history section, as illustrated in FIG. 16. FIG. 16 illustrates the history node with geographic and time characteristics provided with each broadcast. However, additional and/or completely different characteristics may be provided for each broadcast, based on the user/advertiser's desired input characteristics.

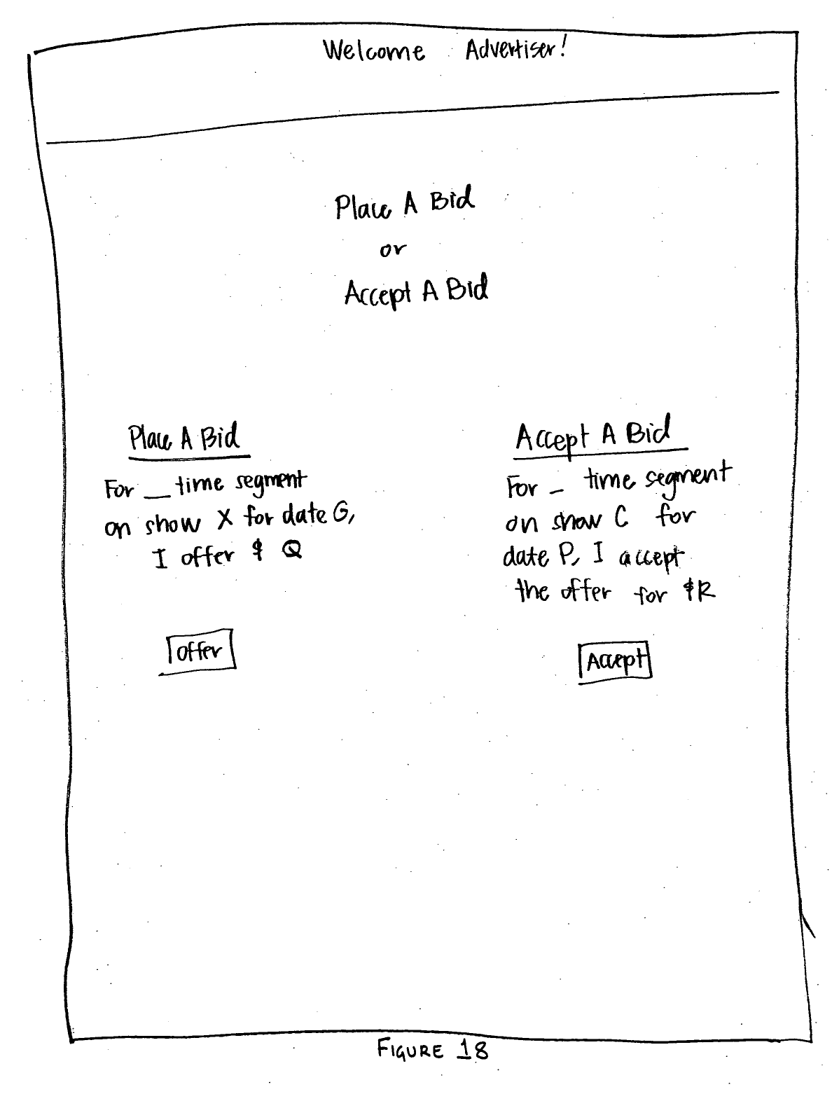

If the user/advertiser wishes to view more information about the East coast broadcast from 10-11 p.m., the user/advertiser may expand the node for the East coast broadcast, as illustrated in FIG. 17. In this case, the East coast broadcast at 10-11 p.m. is a history of World War II aviators. If the advertiser decides that the World War II broadcast is suitable for his business needs, he may place or accept a bid for a segment of time within the broadcast, as illustrated in FIG. 18.

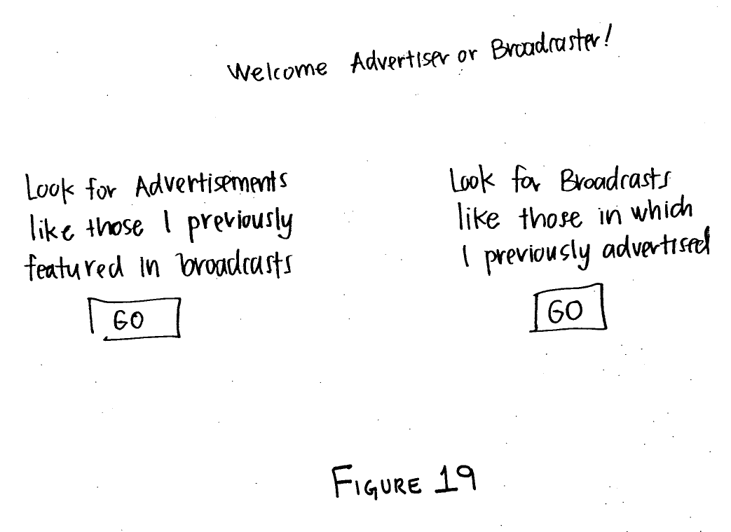

FIG. 19 illustrates a page that may be used by both user/advertisers and user/broadcasters. FIG. 19 represents the polling features of the present invention. More specifically, advertisers may search for broadcasts that are similar to broadcasts in which they previously purchased advertising segments, and user/broadcasters may search for advertisements similar to those previously featured in their broadcasts. Through the search feature, it is possible to optimize a level of matching between user/broadcasters and user/advertisers.

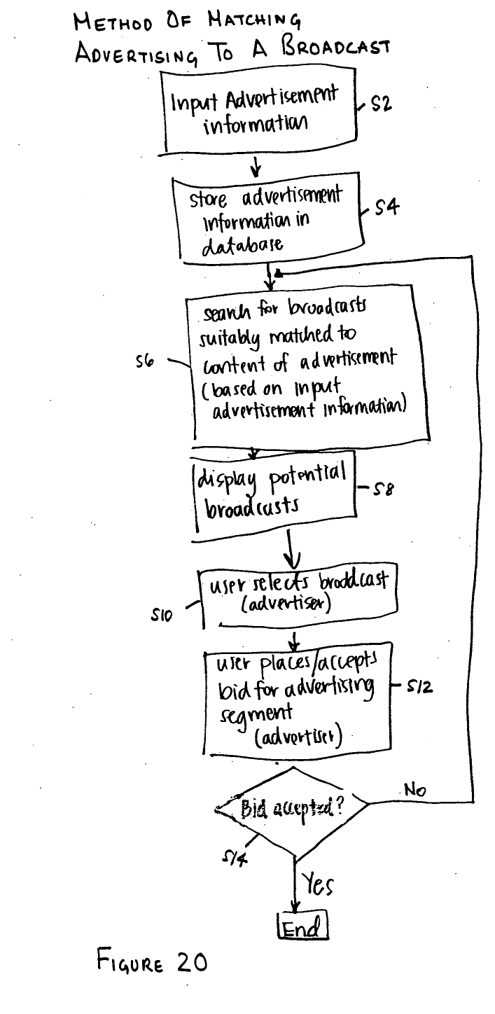

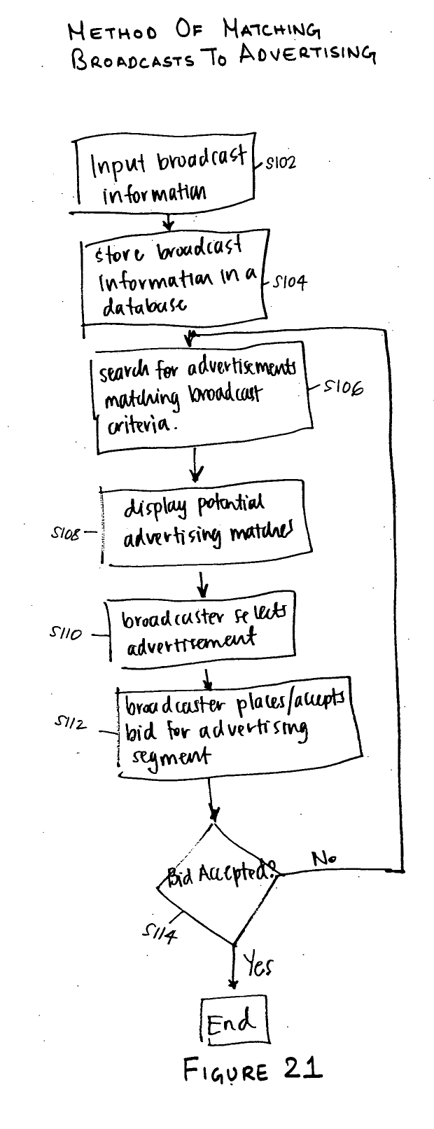

FIG. 20 illustrates a method of matching advertising to a broadcast, according to a non-limiting embodiment of the present invention. In step S2, advertising information is put into the system. In step S4 the advertisement information is stored in a database. In step S6, the Multimedia Advertising Marketplace searches for broadcasts suitably matched to the promotional information of the advertisement or matched based on the input advertisement criteria. In step S8, potential broadcasts matching the advertiser's promotional information or desired characteristics are displayed to the advertiser. In step S10, the user/advertiser selects a desired broadcast, and in step S12 the user/advertiser places and/or accepts a bid for an advertising segment. In step S14, if the bid is accepted, the process ends. Otherwise, if the bid is not accepted, the Multimedia Advertising Marketplace continues to search and display broadcasts as previously described. If the bid has been accepted, a user/advertiser may proceed to contacting the user/broadcaster directly or to making arrangements for payment.

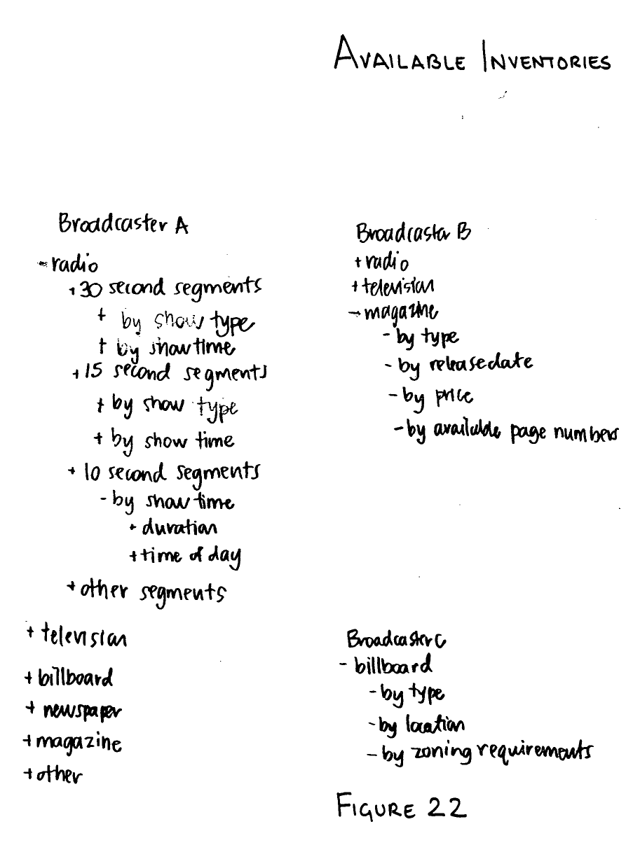

FIG. 21 illustrates a method of matching broadcasts to advertising, according to another non-limiting embodiment of the present invention. In step S102, broadcast information is input into the system. Broadcast information is stored in a database in step S104. The Multimedia Advertising Marketplace searches for advertisements matching broadcast criteria in step S106, and displays potential advertising matches in step S108. In step S110, the user/broadcaster selects a desired advertisement, and the user/broadcaster places and/or accepts a bid for the advertising segment in step S112. In step S114, if the bid is accepted, the user/broadcaster proceeds to the end, and may address payment issues or otherwise contact the advertiser. If the bid is not accepted in step S114, the Multimedia Advertising Marketplace returns to search for advertisements matching broadcast criteria as previously described in step S106. The process is then repeated until a bid is accepted, or until a user/broadcaster desires to exit the system.

For use of the Multimedia Advertising Marketplace, it is possible to charge fees, as a brokerage or sale facilitator. These fees may be collected via the internet or other communication means, such as using Paypal®. Alternatively, the user may directly enter a credit card number to be billed by the marketplace or directly by the user/broadcaster.

Payment for purchases of advertising time may be made directly between the user/broadcaster and advertiser, or may be facilitated by the Multimedia Advertising Marketplace. Any known financial transactions methods, such as wire transfers, payments by Paypal®, checks, and credit cards may be used.

As an alternative embodiment, it is also possible for broadcasters to exchange advertising segment inventory with each other. For example, a user/broadcaster may have 200 radio advertising segments and 10 television advertising segments. However, the user/broadcaster may have received requests from 20 advertisers each desiring 2 television advertising segments. Through the present invention, the user/broadcaster may access available television advertising segments from other user/broadcasters. An illustration of the screen a user/broadcaster may access to view the advertising segment inventories of other user/broadcasters is shown in FIG. 22. The types of inventory that may be exchanged include, but are not limited to, radio, computer, newspaper, magazine, television, online banners, pop-up messages, and outdoor billboards, such as billboards on buses, at bus stations, and along the highway.

As illustrated in FIG. 22, several broadcasters may be visible to anyone of a number of advertiser/users. In the non-limiting example of FIG. 22, Broadcaster A has several types of advertising inventory available. For example, Broadcaster A has a variety of radio advertising segments available. As shown in FIG. 22, it is possible to list the types of segments available by time, by show time, by show type, by a duration of the show, by a time of day that the show is presented, as well as any one of a number of other ways known to those of ordinary skill in the art. FIG. 22 illustrates an example where a broadcaster, Broadcaster B, has magazine segments available. Like the radio segments, magazine advertising segments may be listed by type, by release date, by price, or by available page numbers, as non-limiting examples. Other ways of listing available magazine advertising segments would be obvious to those of skill in the art, and are included in the scope of the present invention. Likewise, the non-limiting example of Broadcaster C illustrates available billboard advertisements. These advertisement inventories may be listed by type, by location of the billboard, and by zoning requirements. Other ways of listing available billboard advertising segments would be readily apparent to those of skill in the art, and are included in the scope of the present invention.

Similarly, television advertising segments, newspaper advertising segments, and other advertising segments may be displayed in manners analogous to those explained with regard to radio, magazine, and billboard advertisements. The manners of presenting the advertisements available in different broadcasting inventories would be readily apparent to those skilled in the art, and are included in the scope of the present invention.

Other user/broadcasters may list all or any part of their advertising segment inventories. The other user/broadcasters may or may not list offering prices. The exchange of advertising segments between user/broadcasters may otherwise occur in a manner similar to the exchanges described herein between user/advertisers and user/broadcasters.

Obviously, numerous modifications and variations of the present invention are possible in light of the above teachings. It is therefore to be understood that within the scope of the appended claims, the invention may be practiced otherwise than as specifically described herein.

1. A method for matching advertisements with broadcasts, comprising:
receiving at least one characteristic of an advertisement into a pool of available advertisements;
searching the pool of available advertisements for a broadcasting match to the at least one characteristic; and
signaling that the advertisement matches the at least one characteristic,
wherein the at least one characteristic includes a type of broadcast.

2. The method of claim 1, further comprising:
enabling a user to contact a representative of the advertisement to negotiate to use the advertisement during a broadcast.

3. The method of claim 1, wherein the type of broadcast includes at least one of newspaper, television, computer, billboard, radio broadcast, online banner, or pop-up message.

4. A method for matching advertisements with broadcasts, comprising:
receiving at least one characteristic of a broadcast into a pool of available broadcasts;
searching the pool of available broadcasts for an advertising match to the at least one characteristic; and
signaling that the broadcast matches the at least one characteristic,
wherein the at least one characteristic includes a type of broadcast.

5. The method of claim 4, further comprising:
enabling a user to contact a representative of the broadcast to negotiate to obtain an advertising segment in the broadcast.

6. The method of claim 4, wherein the type of broadcast includes at least one of newspaper, television, computer, billboard, radio broadcast, online banner, or pop-up message.

7. A method for matching broadcasts with advertisements, comprising:
receiving at least one first characteristic of a broadcast into a pool of available broadcasts;
receiving at least one second characteristic of an advertisement into a pool of available advertisements;
searching the pool of available broadcasts and the pool of available advertisements for a match between the at least one first characteristic or the at least one second characteristic; and
signaling that the advertisement matches the at least one first characteristic or that the broadcast matches the at least one second characteristic,
wherein at least one of the first characteristic and the second characteristic includes a type of broadcast.

8. The method of claim 7, further comprising:
enabling a user to contact at least one of a representative of the broadcast and a representative of the advertisement to negotiate to obtain an advertising segment in the broadcast or to use the advertisement in the broadcast.

9. The method of claim 7, wherein the type of broadcast includes at least one of newspaper, television, computer, billboard, radio broadcast, online banner, or pop-up message.

10. A method for matching advertisements with broadcasts, comprising:
displaying at least one first characteristic of at least one first available broadcast from a pool of available broadcasts; and
enabling a user to select the at least one available first broadcast based on the at least one first characteristic,
wherein the at least one first characteristic includes a type of broadcast.

11. The method of claim 10, further comprising displaying at least one second characteristic of at least one available second broadcast from the pool of available broadcasts.

12. The method of claim 10, further comprising searching the pool of available broadcasts based on the at least one second characteristic.

13. The method of claim 12, further comprising displaying a result of the searching.

14. The method of claim 10, wherein the type of broadcast includes at least one of newspaper, television, computer, billboard, radio broadcast, online banner, or pop-up message.

15. A method for matching broadcasts with advertisements, comprising:
displaying at least one first characteristic of at least one available advertisement from a pool of available advertisements; and
enabling a user to select the at least one available advertisement based on the at least one characteristic,
wherein the at least one first characteristic includes a type of broadcast.

16. The method of claim 15, further comprising displaying at least one second characteristic of at least one available broadcast from the pool of available broadcasts.

17. The method of claim 16, further comprising searching the pool of available broadcasts based on the at least one second characteristic.

18. The method of claim 17, further comprising displaying a result of the searching.

19. The method of claim 15, wherein the type of broadcast includes at least one of newspaper, television, computer, billboard, radio broadcast, online banner, or pop-up message.

20. A system for matching broadcasts with advertisements, comprising:
a database containing information related to at least one of a broadcast and an advertisement;
a search engine configured to search the database based on at least one characteristic received; and
a signal to indicate that the at least one characteristic matches at least one of the at least one broadcast and at least one advertisement,
wherein the at least one characteristic includes a type of broadcast.

21. The system of claim 20, wherein the information includes at least one of a broadcast time, a segment length, an advertising content, a broadcast content, a broadcast representative, an advertising representative, and a geographic restriction.

22. The system of claim 20, wherein the signal includes at least one of an instant message, an email, a facsimile message, a voicemail message, and a telephone call.

23. The method of claim 20, wherein the type of broadcast includes at least one of newspaper, television, computer, billboard, radio broadcast, online banner, or pop-up message.

24. A system for providing advertisers with access to advertising segments in broadcasts, the system comprising:
a database comprising information describing available advertising segments in broadcasts; and
a controller configured to provide said information to a remote terminal through a communication medium and to process a selection of a first available advertising segment in said database from the remote terminal,
wherein said information includes a type of broadcast.

25. The system of claim 24, wherein said information comprises information regarding a cost of said available advertising segment.

26. The system of claim 25, wherein said information further comprises the geographical location in which the advertising segment will be broadcast.

27. The system of claim 26, wherein said information further comprises a duration of the advertising segment.

28. The system of claim 27, wherein said information further comprises a type of broadcast.

29. The system of claim 24, wherein said communication medium includes the internet.

30. The system of claim 24, wherein said remote terminal includes a personal computer.

31. The system of claim 24, wherein said remote terminal includes a wireless terminal.

32. The system of claim 24, wherein said controller is configured to receive a set of search criteria from said remote terminal and to provide a list of advertising segments that satisfy at least a portion of said search criteria.

33. The method of claim 24, wherein the type of broadcast includes at least one of newspaper, television, computer, billboard, radio broadcast, online banner, or pop-up message.
